(19) United States
(12) Patent Application Publication
(10) Pub. No.: US 2025/0234240 A1
(43) Pub. Date: Jul. 17, 2025

(54) TRAFFIC HANDLING FOR DEVICES OPERATING BEHIND A RELAY NODE

(71) Applicant: LENOVO (SINGAPORE) PTE. LTD, Singapore (SG)

(72) Inventors: Apostolis SALKINTZIS, Athens (GR); Genadi VELEV, Darmstadt (DE)

(21) Appl. No.: 18/849,147

(22) PCT Filed: May 31, 2022
(86) PCT No.: PCT/EP2022/064733

§ 371 Date: Sep. 20, 2024

(30) Foreign Application Priority Data
Mar. 21, 2022 (GR) 20220100244

(51) Int. Cl. H04W 28/02; H04L 47/24; H04W 12/06; H04W 76/10

(52) U.S. Cl. CPC H04W 28/0268; H04L 47/24; H04W 12/06; H04W 76/10

(57) ABSTRACT

There is provided a method in an apparatus arranged to communicate with a first mobile communication network. The method comprises establishing a data connection with the first mobile communication network, the data connection comprising of a set of quality of service (QoS) flows, the data connection controlled by a session management function (SMF) in the first mobile communication network. The method further comprises sending a first session management message to the session management function, the first session management message comprising an identity of a first device, the first session management message comprising a request for authorizing the first device to connect to the apparatus. The method further comprises receiving a second session management message from the session management function, the second session management message indicating that the first device has been authorized, and the second session management message comprising QoS information associated with the first device. The method further still comprises applying QoS information to data traffic between the first device and the first mobile communication network.

### FIELD

The subject matter disclosed herein relates generally to the field of traffic handling for devices operating behind a relay node. This document defines a plurality of apparatus and a plurality of methods.

### BACKGROUND

A residential gateway such as a 5G residential gateway (5G-RG) is a gateway device that registers with a core network and establishes a data connection via this core network towards a Data Network such as the Internet. The residential gateway then enables other devices to obtain connectivity to the Data Network by sharing its data connection. The other devices are typically referred to as devices operating “behind” the residential gateway.

The residential gateway forwards traffic to and from each device connected thereto. This forwarded traffic is typically managed by the core network as if it were directed to the residential gateway. Improved traffic handling capabilities would allow for improved network resource management.

### SUMMARY

A problem with prior art arrangements is that forwarded traffic is typically managed by the core network as if it were directed to the relay node. There is a need for traffic handling capabilities that allows for traffic to each device connected to a relay node to be individually managed. Such individual management might comprise applying tailored QoS requirements to traffic to and from each connected device.

Disclosed herein are procedures for traffic handling for devices operating behind a relay node. Said procedures may be implemented by a relay node, a residential gateway and a session management function in a wireless communication network.

There is provided an apparatus comprising a transceiver and a processor. The transceiver is arranged to communicate with a first mobile communication network. The processor is arranged to: establish a data connection with the first mobile communication network, the data connection comprising a set of quality of service (QoS) flows, the data connection controlled by a session management function (SMF) in the first mobile communication network; and send a first session management message to the session management function, the first session management message comprising an identity of a first device, the first session management message comprising a request for authorizing the first device to connect to the apparatus. The processor is further arranged to receive a second session management message from the session management function, the second session management message indicating that the first device has been authorized to connect to the apparatus, and the second session management message comprising QoS information associated with the first device; and apply the QoS information to data traffic between the first device and the first mobile communication network.

There is further a method in an apparatus arranged to communicate with a first mobile communication network. The method comprises establishing a data connection with the first mobile communication network, the data connection comprising of a set of quality of service (QoS) flows, the data connection controlled by a session management function (SMF) in the first mobile communication network. The method further comprises sending a first session management message to the session management function, the first session management message comprising an identity of a first device, the first session management message comprising a request for authorizing the first device to connect to the apparatus. The method further comprises receiving a second session management message from the session management function, the second session management message indicating that the first device has been authorized, and the second session management message comprising QoS information associated with the first device. The method further still comprises applying QoS information to data traffic between the first device and the first mobile communication network.

There is further provided an apparatus in a first mobile communication network, the apparatus comprising a transceiver and a processor. The transceiver is arranged to communicate with a relay node. The processor is arranged to establish a data connection between the first mobile communication network and the relay node, the data connection comprising a set of quality of service (QoS) flows. The processor is further arranged to receive a first session management message from the relay node, the first session management message comprising an identity of a first device, the first session management message comprising a request for authorizing the first device to connect to the relay node. The processor is further arranged to send a second session management message to the relay node, the second session management message indicating that the first device has been authorized, and the second session management message comprising QOS information associated with the first device.

There is further provided a method in an apparatus in a first mobile communication network, the apparatus arranged to communicate with a relay node. The method comprises establishing a data connection between the first mobile communication network and the relay node, the data connection comprising of a set of quality of service (QoS) flows. The method further comprises receiving a first session management message from the relay node, the first session management message comprising an identity of a first device, the first session management message comprising a request for authorizing the first device to connect to the relay node. The method further still comprises sending a second session management message to the relay node, the second session management message indicating that the first device has been authorized, and the second session management message comprising QoS information associated with the first device.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for traffic handling for devices operating behind a relay node will now be described, by way of example only, with reference to the accompanying drawings, in which:

FIG. 1 illustrates a 5G-RG, that has established a data connection with a data network via a 5G core network;

FIG. 2 depicts a user equipment apparatus;

FIG. 3 depicts further details of the network node;

FIG. 4 illustrates a method in an apparatus arranged to communicate with a first mobile communication network;

FIG. 5 illustrates a method in an apparatus in a first mobile communication network;

FIG. 6 illustrates a system comprising Non-5G Capable WLAN device behind a 5G-RG;

FIG. 7 illustrates an NSWO authentication procedure; Figure S illustrates two devices operating behind a 5G-RG; and

FIG. 9 is a messaging diagram illustrating a procedure as presented herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, bur mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware, modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in derail to avoid obscuring aspects of the disclosure.

Aspects of the disclosed method and apparatus are described below with reference to schematic flowchart diagrams and/or schematic block diagrams of methods, apparatuses, systems, and program produces. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

A requirement of the 5G Wireless/Wireline Convergence (5WWC) study in 3GPP Rel-18, is that (a) it shall be possible for a 5G core network to identify the traffic of a device operating behind a 5G Residential Gateway (5G-RG); and (b) it shall be possible for the 5G core network to apply certain QoS handling to the traffic of a device operating behind a 5G-RG.

The first requirement (a) enables the 5G core network to identify and, possibly, charge the traffic of every device operating behind a 5G-RG, while the second requirement (b) enables the 5G core network to provide different QoS handling to the traffic of every device operating behind the 5G-RG.

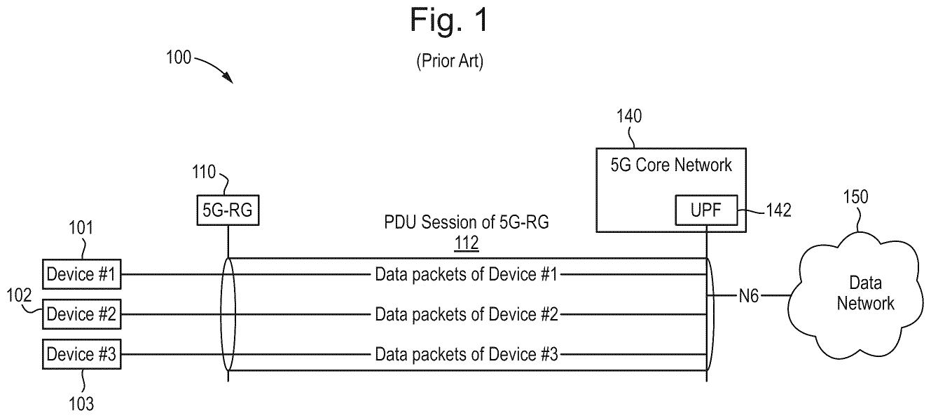

FIG. 1 illustrates a 5G-RG 110, that has established a data connection with a data network 150 via a 5G core network 140. The 5G core network 140 includes a user plane function (UPF) 142. At least one device is arranged to communicate with the 5G-RG 110. In this example, first device 101, second device 102, and third device 103 communicate with the 5G-RG 110. The data connection is a PDU session 112 that carries data packets from each device that communicates with the 5G-RG 110; in this example that is each of the first device 101, second device 102, and third device 103. The 5G-RG 110 is a gateway for each device communicating therewith to connect to the 5G core network 140 and to send and receive data packets to and from the data network 150. The devices 101, 102, 103 may comprise a UE 200, an AUN3 Device 601, a UE 701, a remote unit 805, 807, or an AUN3 device 901 as described herein. The 5G-RG 110 may comprise a residential gateway, a UE 200, a 5G-RG 610, a WLAN AN 720, a 5G-RG 821, or a 5G-RG 910 as described herein. The 5G Core network 140 may comprise a network node 300, a 5G network a 630, a 5G network b 640, a first mobile core network 840, a second mobile core network 850, a PLMN 940, or an HPLMN 950 as described herein.

In operation, the 5G-RG 110 is a gateway device that registers with a 5G core network 140, establishes a data connection (aka PDU Session 112) via this 5G core network 140 towards a Data Network 150 (such as the Internet), and then enables other devices 101, 102, 103 to obtain connectivity to the Data Network 150 by sharing its data connection. These devices 101, 102, 103 are typically referred to as devices operating “behind” the 5G-RG 110 and these can have different capabilities.

For example, a device may have 5G credentials and may be able to use the Non-Access Stratum (NAS) protocol to connect to a 5G core network while operating behind the 5G-RG. Such device is termed as User Equipment (UE).

As another example, a device may not be able to use the Non-Access Stratum (NAS) protocol to connect to a 5G core network while operating behind the 5G-RG. Such device is termed as Non-3GPP device and it is distinguished into two sub-types dependent on whether or not the Non-3GPP device has 5G credentials. A Non-3GPP device that has 5G credentials (e.g., stored in a USIM module) and is capable of authenticating with a 5G core network using these credentials is termed as. Authenticable Non-3GPP (AUN3) device. A Non-3GPP device that has no 5G credentials and is not capable of authenticating with a 5G core network is termed as Non. Authenticable Non-3GPP (NAUN3) device.

Based on the first requirement (a) mentioned above, a mechanism is required for the 5G core network 140 in FIG. 1 to be able to identify the traffic of every device 101, 102, 103 operating behind the 5G-RG 110. Such identification may facilitate charging for the cost of carrying data traffic to an appropriate party. Based on the second requirement (b) mentioned above, a mechanism is also required for the 5G core network 140 in FIG. 1 to be able to provide different QoS handling to the traffic of every device operating behind the 5G-RG.

The methods and apparatus described herein focus on Authenticable Non-3GPP (AUN3) devices, and provide a solution to the above identified problems.

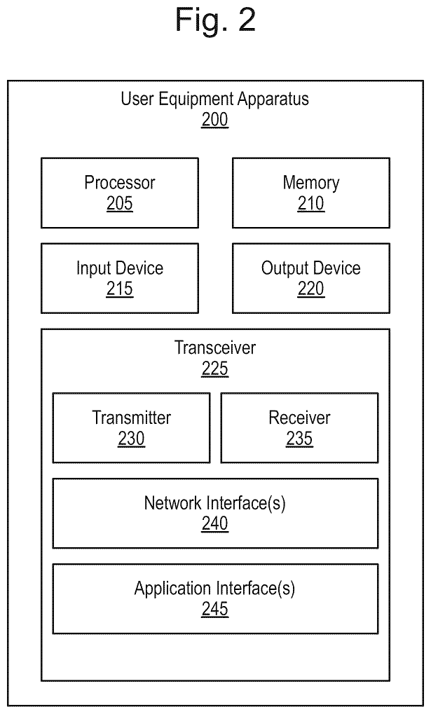

FIG. 2 depicts a user equipment apparatus 200 that may be used for implementing the methods described herein. The user equipment apparatus 200 is used to implement one or more of the solutions described above. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, bur communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

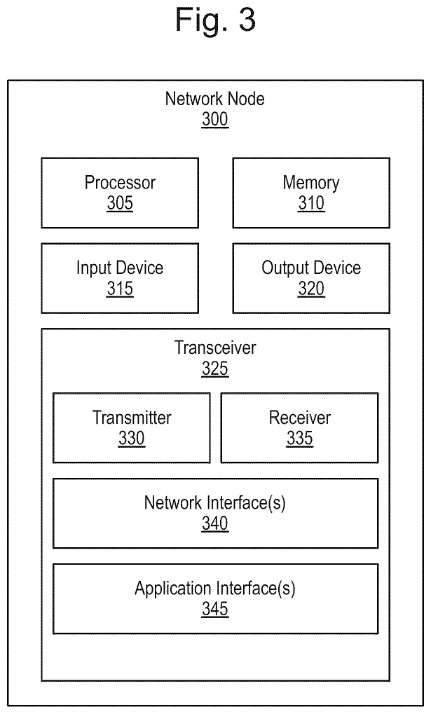

FIG. 3 depicts further details of the network node 300 that may be used for implementing the methods described herein. The network node 300 may be one implementation of an entity in the wireless communications network. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340) and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen of similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330) and the receiver(s) 335 may be any suitable type of transmitters and receivers.

There is provided an apparatus comprising a transceiver and a processor. The transceiver is arranged to communicate with a first mobile communication network. The processor is arranged to: establish a data connection with the first mobile communication network, the data connection comprising a set of quality of service (QoS) flows, the data connection controlled by a session management function (SMF) in the first mobile communication network; and send a first session management message to the session management function, the first session management message comprising an identity of a first device, the first session management message comprising a request for authorizing the first device to connect to the apparatus. The processor is further arranged to receive a second session management message from the session management function, the second session management message indicating that the first device has been authorized to connect to the apparatus, and the second session management message comprising QoS information associated with the first device; and apply the QoS information to data traffic between the first device and the first mobile communication network. The request for authorizing the first device to connect to the apparatus may be a request for authorizing the first device to connect to the apparatus and to send data traffic via the data connection of the apparatus.

The apparatus may be a relay node. The relay node may be a relay UE. For example, the relay UE may be a smartphone operating as a mobile hotspot. The apparatus may be a residential gateway. The residential gateway may be a 5G-RG. The apparatus may comprise a residential gateway, a 5G-RG 110, a UE 200, a 5G-RG 610, a WLAN AN 720, a 5G-RG 821, or a 5G-RG 910 as described herein.

Such an apparatus rends to enable the first device to connect to a relay node after being authenticated and/or authorized by the home network of the first device. Further, such an apparatus tends to enable the first device to exchange data packets via the data connection of the relay node with the first mobile communication network, the data packers using a specified QoS flow. Thus, the apparatus tends to enable per-device QoS handling.

The processor may be arranged to establish the data connection with the first mobile communication network by sending a request message, the request message indicating that the session management function must be able to authenticate and authorize a first device for connecting to the apparatus. The request message may indicate that a requirement of the session management function is that it is capable of authenticating and authorizing a first device for connecting to the apparatus.

Applying QOS information to data traffic between the first device and the first mobile communication network may comprise the processor determining a first QoS flow which the data traffic of the first device should be carried by. Data traffic of the first device may be data traffic associated with the first device. Data traffic of the first device may comprise data traffic sent to and from the first device.

If the data connection does not support the first QoS flow, then the processor may be further arranged to modify the data connection to establish also the first QoS flow. The data connection may not support the first QoS flow if the first QoS flow is not a member of the set of QoS flows.

The transceiver may be further arranged to send data traffic associated with the first device over the first QoS flow of the data connection. Data traffic associated with the first device comprises data sent to and from the first device.

The second session management information may comprise a traffic identifier, and the processor is further arranged to mark the data traffic between the first device and the first mobile communication network with the traffic identifier. Such an apparatus tends to enable the first device to exchange data packets via the data connection of the relay node with the first mobile communication network, where each data packet is marked with a unique Traffic Identifier. Each data packet marked in such a way tends to enable per-device traffic identification and charging.

The data connection may be a PDU session. The first device may be an Authenticable Non-3GPP (AUN3) device. The identity of the first device may be a Subscriber Concealed Identity (SUCI).

The first session management message may include a request to authenticate the first device. The first session management message may comprise a request for both authentication of the first device and authorization for the first device to connect to the apparatus. Where the first session management message comprises a request to authorize the first device to connect to the apparatus, the session management function may be arranged to first authenticate the first device and then to authorize the first device to connect to the apparatus. The second session management message may comprise an indication that the first device has been authenticated and authorized to connect to the apparatus.

The first session management message is a PDU Session Third-Party Authentication Request message. The PDU Session Third Party Authentication Request message may include an EAP-Response and/or Identity received from the first device. The first session management message may trigger the SMF to initiate a procedure with a second mobile communication network to authenticate the first device.

The second session management message may be received in response to the first device being successfully authorized to connect to the apparatus. The second session management message may be received in response to the first device being successfully authenticated and authorized to connect to the apparatus. The second session management message may be a PDU Session Third-Party Authentication Result.

The second session management message may comprise at least one of a Traffic Identifier and QoS flow information.

The Traffic Identifier may be carried in all GTP-U datagrams exchanged between the apparatus and a user plane function (UPF) that encapsulate data packers to/from the first device. Via this Traffic Identifier, it may be possible for the UPF to identify the data traffic of each first device behind the apparatus. The Traffic Identifier may be the Subscriber Permanent Identity (SUPI) of the first device. However, due to the security risk of exposing the SUPI, it may be preferable for the Traffic Identifier to contain a value different from SUPI.

The QoS flow information may indicate the QoS flow on which the data traffic of the first device should be sent when carried over the PDU Session of the apparatus. The QoS flow information may comprise a QoS Flow Identity (QFI) and possibly more information that identifies a QoS flow to be used for the data traffic of the first device.

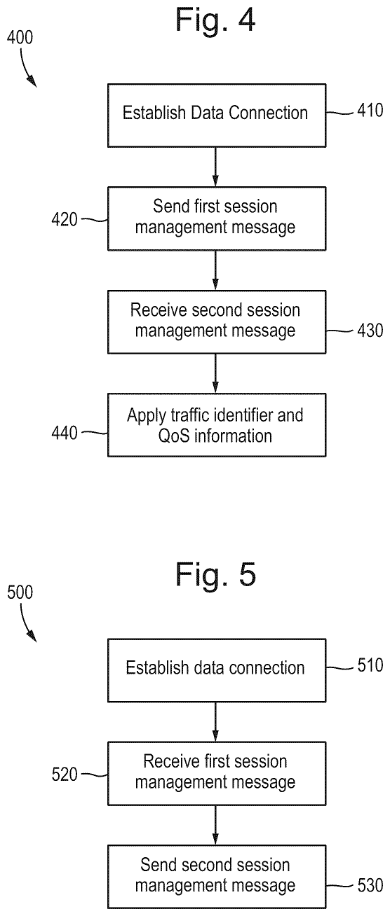

FIG. 4 illustrates a method 400 in an apparatus arranged to communicate with a first mobile communication network. The method 400 comprises establishing 410 a data connection with the first mobile communication network, the data connection comprising of a set of quality of service (QoS) flows, the data connection controlled by a session management function (SMF) in the first mobile communication network. The method 400 further comprises sending 420 a first session management message to the session management function, the first session management message comprising an identity of a first device, the first session management message comprising a request for authorizing the first device to connect to the apparatus. The method 400 further comprises receiving 430 a second session management message from the session management function, the second session management message indicating that the first device has been authorized, and the second session management message comprising QoS information associated with the first device. The method 400 further still comprises applying 440 QoS information to data traffic between the first device and the first mobile communication network.

V: The apparatus may be a relay node. The relay node may be a relay UE. For example, the relay UE may be a smartphone operating as a mobile hotspot. The apparatus may be a residential gateway. The request for authorizing the first device to connect to the apparatus may be a request for authorizing the first device to connect to the apparatus and to send data traffic via the data connection of the apparatus. The residential gateway may be a 5G-RG. The apparatus may comprise a residential gateway, a 5G-RG 110, a UE 200, a 5G-RG 610, a WLAN AN 720, a 5G-RG 821, or a 5G-RG 910 as described herein.

Such an apparatus tends to enable the first device to connect to a relay node after being authenticated and/or authorized by the home network of the first device. Further, such an apparatus tends to enable the first device to exchange data packets via the data connection of the relay node with the first mobile communication network, the data packers using a specified QoS flow. Thus, the apparatus tends to enable per-device QoS handling.

Applying QOS information to data traffic between the first device and the first mobile communication network may comprise the processor determining a first QoS flow which the data traffic of the first device should be carried by.

The method may further comprise, if the data connection does not support the first QoS flow, modifying the data connection to establish also the first QoS flow. The data connection may not support the first QoS flow if the first QoS flow is not a member of the set of QoS flows.

The method may further comprise sending data traffic associated with the first device over the first QoS flow of the data connection. Data traffic associated with the first device comprises data sent to and from the first device.

The second session management information may comprise a traffic identifier, and the method may further comprise marking the data traffic between the first device and the first mobile communication network with the traffic identifier. Such a method tends to enable the first device to exchange data packets via the data connection of the relay node with the first mobile communication network, where each data packet is marked with a unique Traffic Identifier. Each data packet marked in such a way tends to enable per-device traffic identification and charging.

The data connection may be a PDU session. The first device may be an Authenticable Non-3GPP (AUN3) device. The identity of the first device may be a Subscriber Concealed Identity (SUCI).

The first session management message may include a request to authenticate the first device. The first session management message may comprise a request for both authentication of the first device and authorization for the first device to connect to the apparatus. Where the first session management message comprises a request to authorize the first device to connect to the apparatus, the session management function may be arranged to first authenticate the first device and then to authorize the first device to connect to the apparatus. The second session management message may comprise an indication that the first device has been authenticated and authorized to connect to the apparatus. The authorization of the first device to connect to the apparatus may also be an authorization of the first device to send data traffic via the data connection of the apparatus.

The first session management message may be a PDU Session Third-Party Authentication Request message. The PDU Session Third-Party Authentication Request message may include an EAP. Response and/or Identity received from the first device.

The first session management message may trigger the SME to initiate a procedure with a second mobile communication network to authenticate the first device and to authorize the first device to connect to the apparatus. The authorization of the first device to connect to the apparatus may also be an authorization of the first device to send data traffic via the data connection of the apparatus.

The second session management message may be received in response to the first device being successfully authenticated and authorized to connect to the apparatus. The authentication and the authorization of the first device may be performed in the same procedure. If the authentication and authorization is successful, the second session management message may contain the QoS information and (optionality) the traffic identifier. If the authentication and authorization is not successful, the second session management message does not contain QoS information and a traffic identifier; it contains an error result instead.

The second session management message may be a PDU Session Third-Party Authentication Result.

The second session management message may comprise at least one of a Traffic Identifier and QoS flow information. The Traffic Identifier may be carried in all GTP-U datagrams exchanged between the apparatus and UPF that encapsulate data packets to/from the first device. Via this Traffic Identifier, it may be possible for the UPF to identify the data traffic of each first device behind the apparatus. The Traffic Identifier may be the Subscriber Permanent Identity (SUPI) of the first device. However, due to the security risk of exposing the SUPI, it may be preferable for the Traffic Identifier to contain a value different from SUPI. The QoS flow information may indicate the QoS flow on which the data traffic of the first device should be sent when carried over the PDU Session of the apparatus. The QoS flow information may comprise a QoS Flow Identity (QFD) and possibly more information that identifies a QOS flow to be used for the data traffic of the first device.

There is further provided an apparatus in a first mobile communication network, the apparatus comprising a transceiver and a processor. The transceiver is arranged to communicate with a relay node. The processor is arranged to establish a data connection between the first mobile communication network and the relay node, the data connection comprising a set of quality of service (QoS) flows. The processor is further arranged to receive a first session management message from the relay node, the first session management message comprising an identity of a first device, the first session management message comprising a request for authorizing the first device to connect to the relay node. The processor is further arranged to send a second session management message to the relay node, the second session management message indicating that the first device has been authorized, and the second session management message comprising QoS information associated with the first device.

The apparatus may comprise a comprise a 5G Core network 140, a network node 300, a 5G network a 630, a 5G network b 640, a first mobile core network 840, a second mobile core network 850, a PLMN 940, or an HPLMN 950 as described herein. Further, the apparatus may comprise an SMF 636, an SMF 646, and an SMF 845 as described herein. The apparatus in a first mobile communication network may be an SMF. The relay node may be a relay UE. For example, the relay UE may be a smartphone operating as a mobile hotspot. The relay node may be a residential gateway. The residential gateway may be a 5G-RG. The request for authorizing the first device to connect to the apparatus may be a request for authorizing the first device to connect to the apparatus and to send data traffic via the data connection of the apparatus.

The relay node may be arranged to apply the traffic identifier and the QoS information to data traffic between the first device and the first mobile communication network.

Such an apparatus rends to enable the first device to connect to the relay node after being authenticated and/or authorized by the home network of the first device. Further, such an apparatus tends to enable the first device to exchange data packets via the data connection of the relay node with the first mobile communication network, the data packers using a specified QoS flow. Thus, the apparatus tends to enable per-device QoS handling.

The processor may be further arranged to authorize the first device to connect to the relay node, and wherein the second session management message is sent in response to the first device being authorized to connect to the apparatus. The second session management message may be sent in response to the first device being successfully authenticated.

The second session management information may comprise a traffic identifier. The relay node may be arranged to apply the traffic identifier to data traffic between the first device and the first mobile communication network. Such an apparatus tends to enable the first device to exchange data packets via the data connection of the relay node with the first mobile communication network, where each data packet is marked with a unique Traffic Identifier. Each data packet marked in such a way tends to enable per-device traffic identification and charging. The first device may be an Authenticable Non-3GPP (AUN3) device.

The first session management message may include a request to authenticate the first device. The first session management message may be a PDU Session Third-Party Authentication Request message. The PDU Session Third Party Authentication Request message may include an EAP-Response and/or Identity received from the first device. The first session management message may trigger the apparatus to initiate a procedure with a second mobile communication network to authenticate the first device.

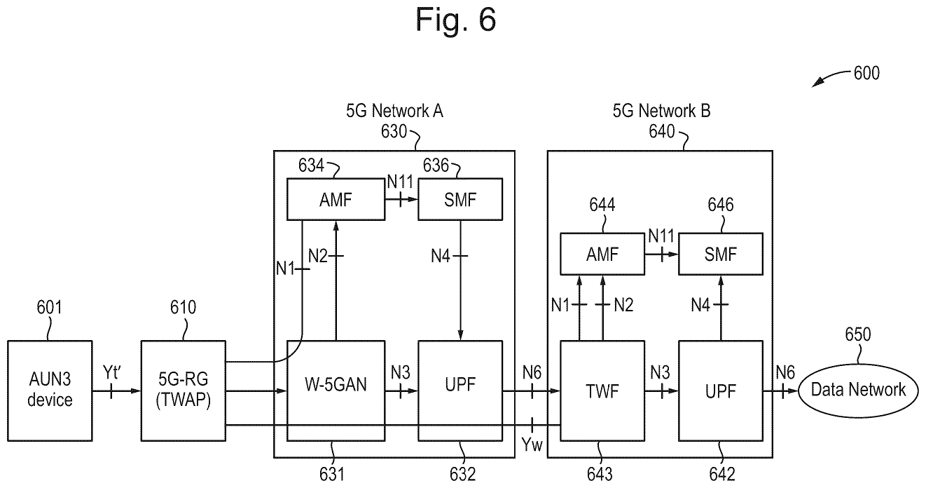

FIG. 5 illustrates a method 500 in an apparatus in a first mobile communication network, the apparatus arranged to communicate with a relay node. The method 500 comprises establishing 510 a data connection between the first mobile communication network and the relay node, the data connection comprising of a set of quality of service (QoS) flows. The method 500 further comprises receiving 520 a first session management message from the relay node, the first session management message comprising an identity of a first device, the first session management message comprising a request for authorizing the first device to connect to the relay node. The method 500 further still comprises sending 530 a second session management message to the relay node, the second session management message indicating that the first device has been authorized, and the second session management message comprising QoS information associated with the first device.

The apparatus may comprise a comprise a 5G Core network 140, a network node 300, a 5G network a 630, a 5G network b 640, a first mobile core network 840, a second mobile core network 850, a PLMN 940, or an HPLMN 950 as described herein. Further, the apparatus may comprise an SMF 636, an SMF 646, and an SMF 845 as described herein. The apparatus in a first mobile communication network may be an SMF. The relay node may be a relay UE. For example, the relay UE may be a smartphone operating as a mobile hotspot. The relay node may be a residential gateway. The residential gateway may be a 5G-RG. The first device may be an Authenticable Non-3GPP (AUN3) device. The request for authorizing the first device to connect to the apparatus may be a request for authorizing the first device to connect to the apparatus and to send data traffic via the data connection of the apparatus.

The relay node may be arranged to apply the traffic identifier and the QoS information to data traffic between the first device and the first mobile communication network.

Such an apparatus tends to enable the first device to connect to the relay node after being authenticated and/or authorized by the home network of the first device. Further, such an apparatus tends to enable the first device to exchange data packers via the data connection of the relay node with the first mobile communication network, the data packets using a specified QoS flow. Thus, the apparatus tends to enable per-device QoS handling.

The method may further comprise authorizing the first device to connect to the relay node, and wherein the second session management message is sent in response to the first device being authorized to connect to the apparatus. The second session management message may be sent in response to the first device being successfully authenticated.

The second session management information may comprise a traffic identifier. The relay node may be arranged to apply the traffic identifier to data traffic between the first device and the first mobile communication network. Such an apparatus tends to enable the first device to exchange data packets via the data connection of the relay node with the first mobile communication network, where each data packet is marked with a unique Traffic Identifier. Each data packet marked in such a way tends to enable per-device traffic identification and charging.

The first session management message may include a request to authenticate the first device. The first session management message may be a PDU Session Third-Party Authentication Request message.

The PDU Session Third-Party Authentication Request message may include an EAP-Response and/or Identity received from the first device. The first session management message may trigger the apparatus to initiate a procedure with a second mobile communication network to authenticate the first device.

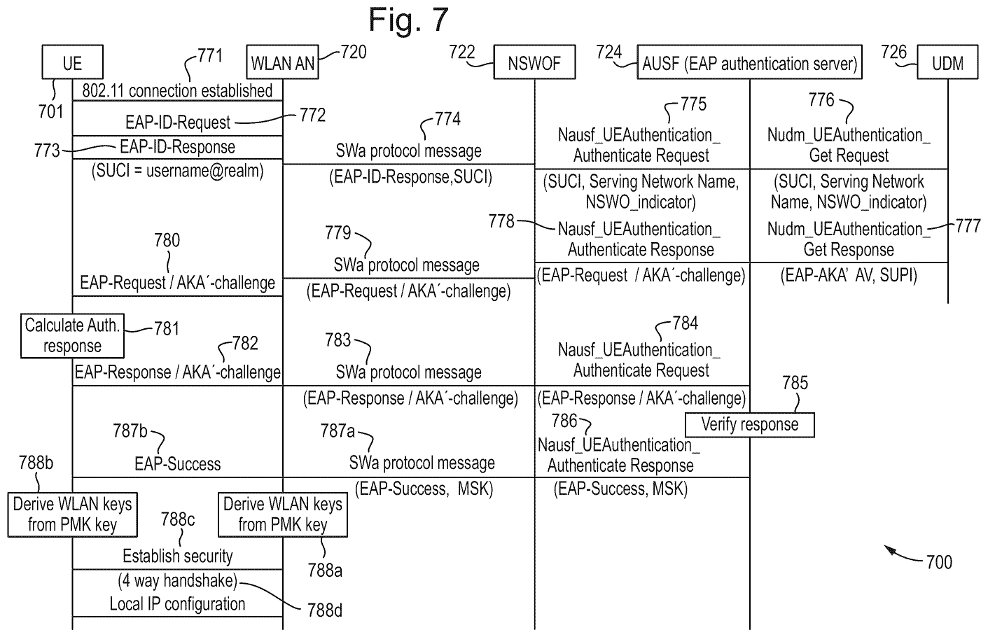

3GPP specification TR 23.700-17 v0.1.0 describes at section 6.3 “Solution 3: Differentiated QoS for N5CW devices behind 5G-RG”. FIG. 6 illustrates a known system 600 comprising Non-5G Capable WLAN (N5CW) device behind a 5G-RG using trusted WLAN access for the N5CW device. The system 600 comprises a AUN3 device 601, a 5G-RG 610, a first wireless communication network, 5G Network A 630, a second wireless communication network, 5G Network B 640, and a data network 650). 5G Network A 630 comprises a Wireline 5G Access network (W-5GAN) 631, a UPF 632, an Access and Mobility management Function (AMF) 634 and a Session Management Function (SMF) 636. 5G Network B 640 comprises a Trusted Wireline Interworking Function (TWIF) 643, a UPF 642, an AMF 644 and an SMF 646. FIG. 6) additionally illustrates the interfaces used for communication between the identified components. The AUN3 Device 601 may comprise devices 101, 102, 103, a UE 200, a UE 701, a remote unit 805, 807, or an AUN3 device 901 as described herein. The 5G-RG 610 may comprise a residential gateway, a 5G-RG 110, a UE 200, a WLAN AN 720, a 5G-RG 821, or a 5G-RG 910 as described herein.

The known system 600 illustrated in FIG. 6 requires that the AUN3 device 601 is authenticated by an authentication function (AUSF) in the HPLMN (5G Network B 640) and as such the AUN3 device 601 is also registered with the HPLMN 640. Furthermore, the known system 600 illustrated in FIG. 6 requires that the HPLMN (5G Network B 640) does not provide any information to 5G Network A 630 that enables the 5G Network A to identify the traffic of the AUN3 device 601 which might allow appropriate QoS handling to this traffic.

In the solution presented herein, the AUN3 device is not required to register with the HPLMN, hence, it is much simpler. Indeed, the solution presented herein supports the capabilities described above, specifically (a) enabling the 5G core network to identify and, possibly, charge the traffic of every device operating behind a 5G-RG, and (b) enabling the 5G core network to provide different QoS handling to the traffic of every device operating behind the 5G-RG. Furthermore, the solution presented herein does this with minimal use of communication bandwidth within the system.

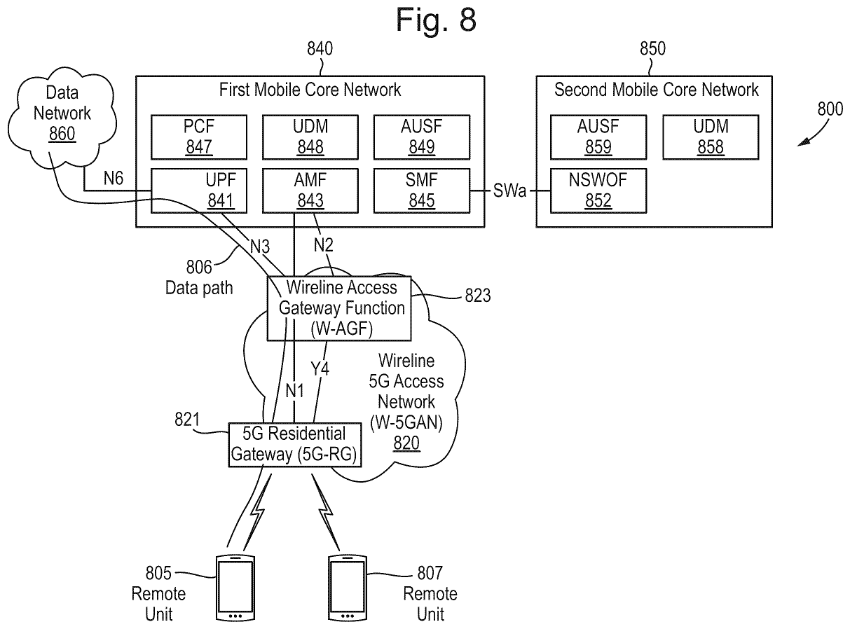

TS 33.501 v17.4.2, annex S describes a Non-Seamless WLAN Offload (NSWO) authentication procedure. FIG. 7 illustrates an NSWO authentication procedure 700, that enables a device having 5G credentials (either UE or AUN3 device) to connect to a WLAN Access Network (AN) after being successfully authenticated and authorized by an AUSF in its Home PLMN. The procedure 700 operates between a UE 701, a WLAN access network 720, an NSWO function (NSWOF) 722, an AUSF 724, and a unified data management (UDM) 726. The a UB 701 may comprise devices 101, 102, 103, a UE 200, an AUN3 Device 601, a remote unit 805, 807, or an AUN3 device 901 as described herein. The WLAN AN 720 may comprise a residential gateway, a 5G-RG 110, a UE 200, a 5G-RG 610, a 5G-RG 821, or a 5G-RG 910 as described herein.

At 771, when the UE decides to perform NSWO, the UE establishes a WLAN connection between the UE and the WLAN Access Network (AN), using procedures specified in IEEE 802.11.

At 772, the WLAN AN sends an EAP Identity/Request to the UE.

At 773, the UE sends an EAP Response/Identity message. The UE shall use the SUCI in NAI format (i.e., username@realm format) as its identity irrespective of whether SUPI Type configured on the USIM is IMSI or NAI. If the SUPI Type configured on the USIM is IMSI, the UE shall construct the SUCH in NAI format with username containing the encrypted MSIN and the realm part containing the MCC/MNC.

At 774, the EAP Response/Identity message shall be routed over the SWa interface towards the NSWO NF based on the realm part of the SUCI.

At 775, the NSWO NF shall send the message Nausf_UEAuthentication_Authenticate Request with SUCI, Serving Network name and NSWO indicator towards the AUSF. NSWQ_indicator is used to indicate to the AUSF that the authentication request is for Non-seamless WLAN offload purposes. The NSWO NF shall set the Serving Network name to “5G:NSWO”.

At 776, the AUSF (acting as the EAP authentication server) shall send a Nudm_UBAuthentication_Get Request to the UDM including SUCI and the NSWO indicator.

At 777, upon reception of the Nudm_UEAuthentication_Get Request, the UDM shall invoke SIDF. SIDF shall de-conceal SUCI to gain SUPI before UDM can process the request. Based on the NSWO indicator, the UDM/ARPF shall select the BAP-AKA′ authentication method. UDM shall generate and include the EAP-AKA′ authentication vector (RAND, AUTN, XRES, CK′ and IK′) and may include SUPI to AUSF in a Nudm_UEAuthentication_Get Response message.

At 778, the AUSF shall store XRES for future verification. The AUSF shall send the EAP-Request/AKA′ Challenge message to the NSWO NF in a Nausf_UEAuthentication_Authenticate Response message.

At 779, the NSWO NE shall send the EAP-Request/AKA′ Challenge message to the WLAN AN over the SWa interface.

At 780, the WLAN AN forwards the EAP-Request/AKA′ Challenge message to the UE.

At 781, at receipt of the RAND and AUTN in the EAP-Request/AKA′ Challenge message, the ME shall construct the SN name by setting it to “5G:NSWO”, and the USIM in the UE shall verify the freshness of the AV′ by checking whether AUTN can be accepted as described in TS 33.102 v16.0.0. If so, the USIM computes a response RES. The USIM shall return RES, CK, IK to the ME. The ME shall derive CK′ and IK′ according to Annex A.3. If the verification of the AUTN fails on the USIM, then the USIM and ME shall proceed as described in sub-clause 6.1.3.3. The UE may derive MSK from CK′ and IK′ as per Annex F and as described in IETF RFC 5448. When the UB is performing NSWO authentication, the K_{AUSF} shall not be generated by the UE.

At 782, the UE shall send the EAP-Response/AKA′ Challenge message to the WLAN AN.

At 783, the WLAN AN forwards the EAP-Response/AKA′-Challenge message over the SWa interface to the NSWO NP.

At 784, the NSWO NF shall send the Nausf_UEAuthentication_Authenticate Request with EAP-Response/AKA′ Challenge message to AUSF.

At 785, the AUSF shall verify if the received response RES matches the stored and expected response XRES. If the AUSF has successfully verified, it continues as follows to step 16, otherwise it returns an error to the NSWO NE. The AUSF shall derive the required MSK key from CK′ and IK′ as per Annex F and as described in RFC 5448, based on the NSWO indicator received in step 5. The AUSF shall not generate the K_{AUSF}.

At 786, the AUSF shall send Nausf_UEAuthentication_Authenticate Response message with EAP-Success and MSK key to NSWO NF. The AUSF may optionally provide the SUPI to NSWO NE. The AUSF/UDM shall not perform the linking increased home control to subsequent procedures.

At 787, the NSWO NF shall send the EAP-success and MSK to WLAN AN over the SWa interface. The EAP-Success message is forwarded from WLAN AN to the DE.

At 788, upon receiving the EAP-Success message, the UE derives the MSK as specified in step 781, if it has not derived the MSK earlier. The UE uses MSK to perform 4-way handshake to establish a secure connection with the WLAN AN.

FIG. 8 illustrates two devices (Remote Units 805 and 807) operating behind a 5G-RG 821. The system 800 illustrated in FIG. 8 comprises a first remote unit 805, a second remote unit 807, a 5G-RG 821, a W-5GAN 820, a W-AGF 823, a first mobile core network 840, a second mobile core network 850, and a data network 860. The first mobile core network 840 comprises a UPF 841, an AMF 843, an SMF 845, a PCF 847, a UDM. 848 and an AUSF 849. The second mobile core network comprises an NSWOF 852, a UDM 858 and an AUSF 859. The remote units 805 and/or 807 may comprise devices 101, 102, 103, a UE 200, an AUN3 Device 601, a UE 701, or an AUN3 device 901 as described herein. The 5G-RG 821 may comprise a residential gateway, a 5G-RG 110, a UE 200, a 5G-RG 610, a WLAN AN 720, or a 5G-RG 910 as described herein.

The 5G-RG 821 registers with the first mobile core network 840 via a wireline 5G access network. (W-5GAN) 820, which contains a wireline access gateway function (W-AGF) 823 that interact with the first mobile core network 840 using the N3 and N2 interfaces.

The first and second Remote Units 805 and 807 possess 5G credentials (e.g., stored in a USIM module) and can be authenticated using these credentials. The second mobile core network 850 stores also the authentication credentials of the Remote Units (it is their Home PLMN) and it is used for authenticating the Remote Units and for authorizing their connection to the first mobile core network 840 via the 5G-RG 821. After the Remote Units connect to the first mobile core network 840 via the 5G-RG 821, they can exchange data traffic with the Data Network 860 as shown in the figure. A data path 806 between remote unit 805 and data network 860 is illustrated in FIG. 8. As specified in the present disclosure, the first mobile core network 840 is able (a) to identify the data traffic of each Remote Unit and, possibly, to charge this traffic, and (b) to provide different QoS handling to the data traffic of each Remote Unit, by using QoS information provided by the second mobile core network 850.

For simplicity, the second mobile core network 850 is assumed to be the home network or Home PLMN of both Remote Units. However, each Remote Unit may have a different Home PLMN.

All the network functions in FIG. 8 (e.g., AMF, SME, UPF, etc.) are network functions already specified in the 3GPP specifications. The present disclosure, however, extends the functionality of some of them. The Non-Seamless WLAN Offload Function (NSWOF) is a network function that enables devices having 5G credentials to connect to WLAN access networks using these 5G credentials (see TS 33.501 v17.4.2, annex S). According to the arrangements described herein, it is used to enable the Remote Units to connect to 5G-RG 821 and send data traffic via the first mobile core network 840. This is accomplished by introducing a SWa interface between the SMF 845 and the NSWOF 852. Note that the SWa interface is not new, however, its utilization by an SME is new.

It is assumed that the Remote Units used WLAN access technology (e.g., based on IEEE 802.11) to communicate with the 5G-RG 821. However, other types of wireless access technologies may also be used.

Although in FIG. 8 the 5G-RG 821 communicates with the first mobile core network 840 via the W-5GAN 820, in other scenarios, the 5G-RG 821 may communicate with the mobile core network 840 via a 5G radio access network (e.g., NG-RAN), or even via multiple different types of access networks (such as, W-5GAN and NG-RAN). This means that the function of the 5G-RG 821 of FIG. 8 may be fulfilled by a “relay” UE, which enables other devices behind the relay UE to obtain connectivity to the Data Network 860.

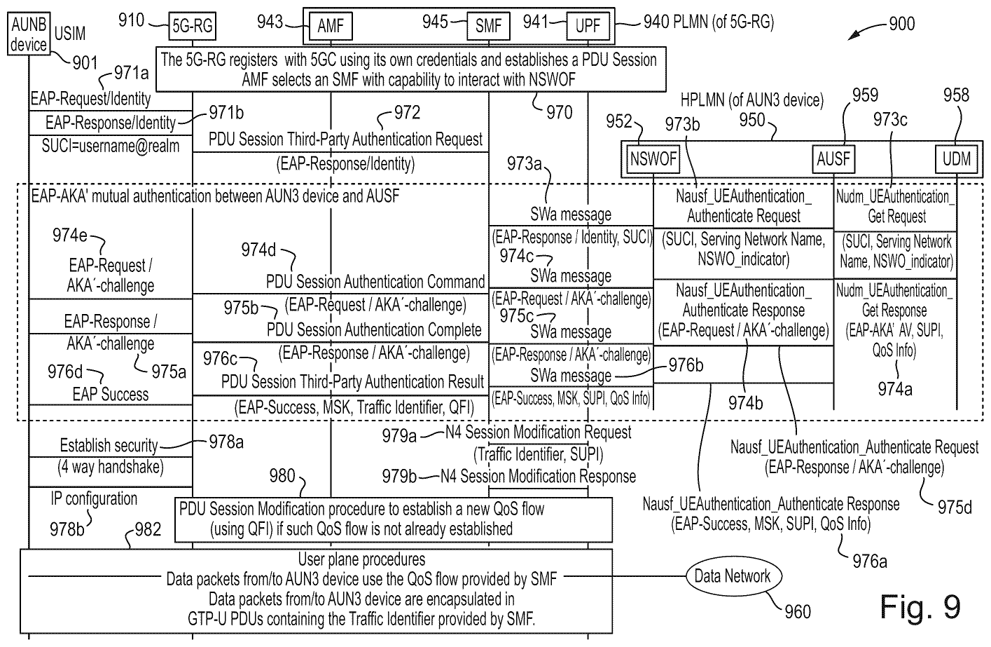

FIG. 9 is a messaging diagram illustrating a procedure 900 as presented herein. The illustrated system comprises an AUN3 device 901, a 5G-RG 010, a PLMN 940, an HPLMN 950, and a data network 960. The 5G-RG 940 is registered to the PLMN 940. The PLMN 940 comprises an AMF 943, an SMF 945, and a UPF 941. HPLMN 950 is the home network of the AUN3 device 901. HPLMN 950 comprises an NSWOF 952, AUSF 959, and UDM 958.

The procedure 900 shown in FIG. 9 tends to support the following capabilities: enabling an Authenticable Non-3GPP (AUN3) device to connect to a 5G-RG after being authenticated and authorized by the HPLMN of the AUN3 device; enabling the AUN3 device to exchange data packets via the PDU Session of 5G-RG, each one marked with a unique Traffic Identifier (thus, it enables per-device traffic identification and charging); and enabling the AUN3 device to exchange data packets via the PDU Session of 5G-RG, all of them using a specified QoS flow (thus, it enables per-device QoS handling).

The Authenticable Non-3GPP (AUN3) device 901 may comprise devices 101, 102, 103, a UE 200, an AUN3 Device 601, a UE 701, or a remote unit 805, 807 as described herein. The 5G-RG 910 may comprise a residential gateway, a 5G-RG 110, a UB 200, a 5G-RG 610, a WLAN AN 720, or a 5G-RG 821 as described herein. The PLMN 940 or HPLMN 950 may comprise a 5G Core network 140, a network node 300, a 5G network a 630, a 5G network b 640, a first mobile core network 840, or a second mobile core network 850 as described herein. Specifically, the PLMN 940 which the 5G-RG 910 is registered with (“PLMN (of 5G-RG)”) is an embodiment of the first mobile core network 840 and the HPLMN 950 of the AUN3 device (“HPLMN (of AUN3 device)”) is an embodiment of the second mobile core network 850.

The procedure 900 begins at 970, where the 5G-RG 910 registers with a 50 come network 940 (“PLMN (of 5G-RG)”) using its own 5G credentials (“USIM”) and establishes a PDU Session, which can be used by devices operating “behind” the 5G-RG, such as, the AUN3 device 901. This PDU Session typically supports one or more QoS flows, each one providing a different QoS handling to the data traffic carried via the QoS flow.

Note that the PDU Session of the 5G-RG 910 may be controlled by an SMF 945 that supports the SWa interface and hence may communicate with multiple NSWOFs 52. If not all SMFs 945 in the PLMN (of 5G-RG) 940 support this capability, then, during this PDU Session establishment, the AMF 943 preferably selects an SMF 945 that supports the SWa interface. The AMF 943 may decide to select an SMF that supports the SWa interface, either because: a) it receives a new indication from the 5G-RG 910, e.g., a new indication in the NAS message sent from the 5G-RG 910 to the AMF 943, which comprises the PDU Session Establishment Request; or b) it receives a new indication in the subscription information of 5G-RG 910 (retrieved from UDM 958), which indicates that all PDU Sessions of this 5G-RG 910 must use an SMF 945 that support the SWa interface.

The alternative a) is preferable because it allows the 5G-RG 910 to send the new indication to AMF 943 only for the PDU Sessions which can be shared by devices “behind” the 5G-RG 910. If, however, the 5G-RG 910 requests a PDU Session which cannot be shared by devices “behind” the 5G-RG 910 (i.e., it is used for the communication needs of 5G-RG 910), then it does not send the new indication to AMF 943 and the AMF 943 does not select an SMF 945 that supports the SWa interface.

At 971, the AUN3 device 901 requests to connect to 5G-RG 910, e.g., it performs a WLAN association with the 5G-RG 910. This triggers the 5G-RG 910 to initiate an EAP-based authentication procedure, hence, it sends an EAP-Request/Identity to AUN3, which responds with an BAP-Response/Identity containing its Subscriber Concealed Identity (SUCI) in a form of a Network Access Identifier (NAI).

At 972, the 5G-RG 910 requests from SMF 945 to authenticate the AUN3 device 901 and to determine whether the AUN3 device 901 is authorized to connect to the 5G-RG 910. For this purpose, the 5G-RG 910 sends a new 5GSM message to SMF 945, called PDU Session Third-Party Authentication Request message. The “Third-Party” signifies that the authentication request is nor for the 5G-RG 910 but for another device operating behind the 5G-RG 910. The PDU Session Third-Party Authentication Request message includes the EAP-Response/Identity received by the AUN3 device 901.

At 973, 974, 975 and 976, an EAP-AKA′ mutual authentication procedure takes places between the AUN3 device 901 and AUSF 959. These steps are the same steps as 4-17 in the NSWO authentication procedure illustrated in FIGS. 6 and 7 referenced above with some differences, these differences are explained in the following paragraphs.

At 974a, the UDM 958 provides not only the Subscriber Permanent Identity (SUPI) of the AUN3 device 901, but also “QoS Info” for the data traffic of the AUN3 device 901. This “QoS Info” is part of the subscription data of the AUN3 device 901 and identifies the QoS parameters that should be applied to handle the data traffic of the AUN3 device 901 when carried over the PDU Session of the 5G-RG 910. For example, the “QoS Info” may contain QoS parameters such as a 5QI value and/or a packet delay budget and/or a packet error rate. The “QoS Info” shall later be used by SMF 945 to determine the QoS flow on which the data traffic of AUN3 device 901 should be sent when carried over the PDU Session of the 5G-RG 910.

The UDM determines to provide the QoS Info based on the information received in step 973c, for example, based on the value of the Serving Network Name, or another parameter.

At 976a, if the authentication procedure is successful, the AUSF 959 provides also the SUPI of the AUN3 device 901 and the QoS Info received from UDM 958.

At 976b, the SUPI and the QOS Info are forwarded to SMF 945. This way the SMF 945 receives the permanent subscriber identity of the AUN3, device 901 which can be used for charging, and receives also information indicating the QoS that should be used to handle the data traffic of the AUN3 device 901.

At 976c, the SMF 945 responds to the 5G-RG 910 with a PDU Session Third-Party Authentication Result message. If the authentication procedure is successful, this message contains, not only the EAP-Success packet and the Master Session Key (MSK), but also a Traffic Identifier and a QFI value.

The Traffic Identifier may be carried in all GTP-U datagrams exchanged between the 5G-RG 910 and UPF 941 that encapsulate data packets to/from the AUN3 device 901. Via this traffic identifier, it becomes possible for UPF 941 to identify the traffic of each AUN3 device 901 behind the 5G-RG 910. This Traffic Identifier could be the SUPI of the AUN3 device 901. However, due to security reasons (i.e., risking exposure of the SUPI), it is deemed preferable for the Traffic Identifier to contain a value different from SUPI. The QFI value may indicate the QoS flow on which the data traffic of AUN3 device 901 should be sent when carried over the PDU Session of the 5G-RG 910.

At 978, after the EAP-Success message is sent, the AUN3 device 901 and the 5G-RG establish a security context to secure the air-interface traffic. In case of WLAN access, this is typically accomplished by applying the 4-way handshake procedure specified in IEEE 802.11. In addition, the AUN3 device obtains IP configuration data, including an IPv4/IPv6 address. After this step, the AUN3 device can start sending data traffic to the Data Network

At 979, the SMF 945 sends the SUPI of the AUN3 device 901 and the associated Traffic Identifier, so that the UPF 941 can identify and, possibly, charge the data traffic of the AUN3 device 901.

At 980, if the QFI provided by the SMF 945 in step 976c corresponds to a QoS flow that does not exist in the PDU Session of the 5G-RG 910, the 5G-RG 910 initiates a PDU Session Modification procedure to establish a new QoS flow.

At 982, the 5G-RG 910 sends the data traffic received from the AUN3 device 901 to the QoS flow corresponding to this AUN3 device 901. Similarly, the UPF 941 sends the data traffic received from the data network 960 and is destined to the AUN3 device 901 to the QoS flow corresponding to this AUN3 device 901. Between the 5G-RG 910 and the UPF 941, the data traffic of the AUN3 device 901 is encapsulated within GTP-U datagrams, each one of which contains the Traffic Identifier that corresponds to this AUN3 device 901. The traffic identifier may be the one provided by SMF 945 in step 976c.

Accordingly, the arrangements described herein enable an Authenticable Non-3GPP (AUN3) device to connect to a 5G-RG after being authenticated and authorized by the HPLMN of the AUN3 device. Further, the AUN3 device is enabled to exchange data packets via the PDU Session of 5G-RG, each one marked with a unique Traffic Identifier (thus, it enables per-device traffic identification and charging). Furthermore the AUN3 device is enabled to exchange data packets via the PDU Session of 5G-RG, all of them using a specified QoS flow (thus, per-device QoS handling is facilitated. The main claims should be targeting the 5G-RG and the SMF. Additional claims should also target the UDM and AUSF. An example 5G-RG claim follows:

There is provided an apparatus comprising a transceiver and a processor. The transceiver communicates with a first mobile communication network. The processor establishes a data connection with the first mobile communication network, the data comprising of a set of quality of service (QoS) flows and being controlled by a session management function (SMF) in the first mobile communication network. The processor further sends a first session management message to the session management function (SME), the first session management message comprising an identity of a first device attempting to connect to the apparatus, wherein the first session management message triggers the SME to initiate a procedure with a second mobile communication network to authenticate the first device. The processor further receives a second session management message from the session management function (SMF), the second session management message comprising a traffic identifier and QoS information associated with the first device (in response to the first device being successfully authenticated). The processor further applies the traffic identifier and the QoS information to transfer the data traffic of the first device via the data connection.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
establish a data connection with a first mobile communication network, the data connection comprising a set of quality of service (QoS) flows, the data connection controlled by a session management function (SMF) in the first mobile communication network;
send a first session management message to the session management function, the first session management message comprising an identity of a first device, the first session management message comprising a request for authorizing the first device to connect to the apparatus;
receive a second session management message from the session management function, the second session management message indicating that the first device has been authorized to connect to the apparatus, and the second session management message comprising QoS information associated with the first device; and
apply the QoS information to data traffic between the first device and the first mobile communication network.

2. The apparatus of claim 1, wherein the at least one processor is configured to cause the apparatus to establish the data connection with the first mobile communication network by sending a request message, the request message indicating that the session management function must be able to authenticate and authorize a first device for connecting to the apparatus.

3. The apparatus of claim 1, wherein at least one processor is configured to cause the apparatus to apply the QoS information to the data traffic between the first device and the first mobile communication network by determining a first QoS flow to carry the data traffic of the first device.

4. The apparatus of claim 3, wherein, when the data connection does not support the first QoS flow, the processor is further configured to cause the apparatus to modify the data connection to establish the first QoS flow.

5. The apparatus of claim 3, wherein the at least one processor is further configured to cause the apparatus to send data traffic associated with the first device over the first QoS flow of the data connection.

6. The apparatus of claim 1, wherein the second session management information comprises a traffic identifier, and wherein the at least one processor is further configured to cause the apparatus to mark the data traffic between the first device and the first mobile communication network with the traffic identifier.

7. The apparatus of claim 1, wherein the first session management message is a packet data unit (PDU) Session Third-Party Authentication Request message.

8. The apparatus of claim 1, wherein the second session management message is received in response to the first device being successfully authenticated and authorized to connect to the apparatus.

9. The apparatus of claim 1, wherein the second session management message is a packet data unit (PDU) Session Third-Party Authentication Result.

10. The apparatus of claim 1, wherein the second session management message comprises at least one of a Traffic Identifier and QoS flow information.

11. A method performed by an apparatus that communicates with a first mobile communication network, the method comprising:
establishing a data connection with the first mobile communication network, the data connection comprising of a set of quality of service (QoS) flows, the data connection controlled by a session management function (SMF) in the first mobile communication network;
sending a first session management message to the session management function, the first session management message comprising an identity of a first device, the first session management message comprising a request for authorizing the first device to connect to the apparatus;
receiving a second session management message from the session management function, the second session management message indicating that the first device has been authorized, and the second session management message comprising QoS information associated with the first device; and
applying QoS information to data traffic between the first device and the first mobile communication network.

12. An apparatus for wireless communication, comprising:
at least one memory; and
at least one processor coupled with the at least one memory and configured to cause the apparatus to:
establish a data connection between a first mobile communication network and a relay node, the data connection comprising a set of quality of service (QoS) flows;
receive a first session management message from the relay node, the first session management message comprising an identity of a first device, the first session management message comprising a request for authorizing the first device to connect to the relay node;
send a second session management message to the relay node, the second session management message indicating that the first device has been authorized, and the second session management message comprising QoS information associated with the first device.

13. The apparatus of claim 12, wherein the at least one processor is further configured to cause the apparatus to authenticate and authorize the first device to connect to the relay node, and wherein the second session management message is sent in response to the first device being successfully authenticated and authorized to connect to the apparatus.

14. The apparatus of claim 12, wherein the second session management information comprises a traffic identifier.

15. The apparatus of claim 12, wherein the apparatus supports the SWa interface.

16. (canceled)

17. A processor for wireless communication, comprising:
at least one controller coupled with at least one memory and configured to cause the processor to:
establish a data connection with a first mobile communication network, the data connection comprising a set of quality of service (QoS) flows, the data connection controlled by a session management function (SMF) in the first mobile communication network;
send a first session management message to the session management function, the first session management message comprising an identity of a first device, the first session management message comprising a request for authorizing the first device to connect to the processor;
receive a second session management message from the session management function, the second session management message indicating that the first device has been authorized to connect to the processor, and the second session management message comprising QoS information associated with the first device; and
apply the QoS information to data traffic between the first device and the first mobile communication network.

18. The processor of claim 17, wherein the at least one controller is configured to cause the processor to establish the data connection with the first mobile communication network by sending a request message, the request message indicating that the session management function must be able to authenticate and authorize a first device for connecting to the processor.

19. The processor of claim 17, wherein at least one controller is configured to cause the processor to apply the QoS information to the data traffic between the first device and the first mobile communication network by determining a first QoS flow to carry the data traffic of the first device

20. The processor of claim 19, wherein, when the data connection does not support the first QoS flow, the controller is further configured to cause the processor to modify the data connection to establish the first QoS flow.

21. The processor of claim 19, wherein the at least one controller is further configured to cause the processor to send data traffic associated with the first device over the first QoS flow of the data connection.
